(19) United States
(12) Patent Application Publication
(10) Pub. No.: US 2024/0172156 A1
(43) Pub. Date: May 23, 2024

(54) METHOD, USER EQUIPMENT, AND NETWORK NODE

(71) Applicant: NEC Corporation, Minato-ku, Tokyo (JP)

(72) Inventors: Maxime GRAU, Leatherhead (GB); Neeraj GUPTA, London (GB); Yuhua CHEN, London (GB)

(73) Assignee: NEC Corporation, Minato-ku, Tokyo (JP)

(21) Appl. No.: 18/284,384

(22) PCT Filed: Mar. 17, 2022
(86) PCT No.: PCT/JP2022/012480

§ 371 Date: Sep. 27, 2023

(30) Foreign Application Priority Data
Apr. 1, 2021 (GB) 2104780.8

(51) Int. Cl. H04W 56/00; H04B 7/185

(52) U.S. Cl. CPC H04W 56/0045; H04B 7/1853; H04W 56/001

(57) ABSTRACT

A communication system is disclosed in which a user equipment (UE) communicate with a base station via a non-terrestrial network. The UE obtains information identifying a threshold associated with a timing advance value applicable for communications between the UE and the network node via the non-terrestrial network, acquires a timing advance value for said communications with the network node, and determines whether to transmit a timing advance report to the network node based on the timing advance value and the threshold.

### TECHNICAL FIELD

The present disclosure relates to communication system.

### BACKGROUND ART

The present invention relates to a wireless communication system and devices thereof operating according to the 3rd Generation Partnership Project (3GPP) standards or equivalents or derivatives thereof. The disclosure has particular but not exclusive relevance to improvements relating to the so-called ‘5G’ (or ‘Next Generation’) systems employing a non-terrestrial portion comprising airborne or spaceborne network nodes.

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect IoT devices and similar MTC devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IoT)/Industrial Internet of Things (IIoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.4.0 and TS 37.340 V16.4.0 define the following nodes, amongst others:
gNB: node providing NR user plane and control plane protocol terminations towards the UE, and connected via the NG interface to the 5G core network (5GC).
ng-eNB: node providing Evolved Universal Terrestrial Radio Access (E-UTRA) user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

3GPP is also working on specifying an integrated satellite and terrestrial network infrastructure in the context of 5G. The term Non-Terrestrial Networks (NTN) refers to networks, or segments of networks, that are using an airborne or spaceborne vehicle for transmission. Satellites refer to spaceborne vehicles in Geostationary Earth Orbit (GEO) or in Non-Geostationary Earth Orbit (NGEO) such as Low Earth Orbits (LEO), Medium Earth Orbits (MEO), and Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS—all operating quasi-stationary at an altitude typically between 8 and 50 km.

3GPP Technical Report (TR) 38.811 V15.4.0 is a study on New Radio to support such Non-Terrestrial Networks. The study includes, amongst others, NTN deployment scenarios and related system parameters (such as architecture, altitude, orbit etc.) and a description of adaptation of 3GPP channel models for Non-Terrestrial Networks (propagation conditions, mobility, etc.). 3GPP TR 38.821 V16.0.0 provides further details about NTN.

Non-Terrestrial Networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere; especially for critical communications, future railway/maritime/aeronautical communications; and
enable 5G network scalability through the provision of efficient multicast/broadcast resources for data delivery towards the network edges or even directly to the user equipment.
   NTN access typically features the following elements (amongst others):
NTN Terminal: It may refer to a 3GPP UE or a terminal specific to the satellite system in case the satellite doesn't serve directly 3GPP UEs.
A service link which refer to the radio link between the user equipment and the space/airborne platform (which may be in addition to a radio link with a terrestrial based RAN).
A space or an airborne platform.
Gateways (‘NTN Gateways’) that connect the satellite or aerial access network to the core network. It will be appreciated that gateways will mostly likely be co-located with a base station.
Feeder links which refer to the radio links between the gateways and the space/airborne platform.

Satellite or aerial vehicles may generate several beams over a given area to provide respective NTN cells. The beams have a typically elliptic footprint on the surface of the Earth.

### 3GPP Intends to Support Three Types of NTN Beams or Cells:

Earth-fixed cells characterized by at least one beam covering the same geographical areas all the time (e.g. GEO satellites and HAPS);
quasi-Earth-fixed cells characterized by at least one beam covering one geographic area for a finite period and a different geographic area during another period (e.g. NGEO satellites generating steerable beams); and
Earth-moving cells characterized by at least one beam covering one geographic area at one instant and a different geographic area at another instant (e.g. NGEO satellites generating fixed or non-steerable beams).

With satellite or aerial vehicle keeping position fixed in terms of elevation/azimuth with respect to a given earth point e.g. GEO and UAS, the beam footprint is earth fixed.

With satellite circulating around the earth (e.g. LEO) or on an elliptical orbit around the earth (e.g. HEO) the beam footprint may be moving over the Earth with the satellite or aerial vehicle motion on its orbit. Alternatively, the beam footprint may be Earth-fixed (or quasi-Earth-fixed) temporarily, in which case an appropriate beam pointing mechanism (mechanical or electronic steering) may be used to compensate for the satellite or aerial vehicle motion.

The term Timing Advance (TA) refers to a parameter that is used for controlling the timing of transmission of signals on the uplink towards the base station to ensure that the signals arrive at the base station at the appropriate time. The greater the value of the TA the earlier the UE needs to transmit a signal in order for that signal to reach the base station at the correct time. In NTN systems signals need to travel longer distances than in non-NTN radio networks since they are relayed via satellites. Thus, the UE's applicable Timing Advance (TA) may be affected by (changes in) one or more of: the UE's position; the serving satellite's position; and the applicable timing offset.

### SUMMARY OF INVENTION

### Technical Problem

The UE's uplink TA may be adversely effected when communicating via NTN because LEO and MEO satellites are moving at a high speed. Although it is not clear how fast satellites are getting closer/farther away from the UE, it will be appreciated that the associated round trip delay (RTD) will change faster in NTN than in legacy network (i.e. non-NTN networks). For example, in terrestrial NR networks, UE uplink timing is updated by the base station (gNB) via a closed loop using the so-called Timing Advance Command (parameter N_{TA_offset}). However, this method would result in an incorrect timing advance value being applied after a very short time (a few seconds).

Incorrect time alignment has an adverse impact on decodability of uplink signals at the base station due to inter-system interface (ISI) and/or frame ambiguity. Moreover, the TA value is also used for applying an appropriate timing offset between the UE and the base station, for example, for scheduling of a UE for the uplink and for determining the start of the response window in the downlink.

The inventors have realised that with the more frequent TA adjustments needed in NTN systems there is an increase in associated signalling between the UE and its serving base station. Whilst it is possible for the UE to derive an appropriate TA value on its own, there are concerns regarding the accuracy of such self-calculated TA values, and additional signalling may be necessary from the network to the UE for TA refinement (e.g. during initial access and/or TA maintenance).

Moreover, the UE and the base station need to have the same Timing Offset. However, the information on which the Timing Offset is based is not symmetrical without reporting by the UE or without using legacy closed loop adjustment by the base station, which methods would be inefficient in NTN or they would be wasteful of resources. If the UE determines the applicable Timing Offset implicitly (e.g. from a TAC (Timing Advance Command)), it is not clear what happens if the UE misses a TAC and/or if the base station needs to send multiple TACs (which may also result in non-symmetrical level of knowledge at the UE and the base station).

The currently proposed methods for maintaining appropriate time alignment require excessive signalling between the UE and the base station (e.g. TA reporting by UE to maintain uplink alignment at gNB side) and/or additional processing/increased battery use at the UE (e.g. open-loop TA maintenance by the UE based on Global Navigation Satellite System (GNSS) positioning).

Accordingly, the present invention seeks to provide methods and associated apparatus that address or at least alleviate (at least some of) the above described issues.

Although for efficiency of understanding for those of skill in the art, the invention will be described in detail in the context of a 3GPP system (5G networks including NTN), the principles of the invention can be applied to other systems as well.

### Solution to Problem

In one aspect, the invention provides a method performed by a user equipment (UE) configured to communicate via a non-terrestrial network, the method comprising: obtaining information identifying a threshold associated with a timing advance value applicable for communications with a network node via the non-terrestrial network; acquiring a timing advance value for said communications with the network node; and determining whether to transmit a timing advance report to the network node based on the timing advance value and the threshold.

In one aspect, the invention provides a method performed by a user equipment (UE) configured to communicate via a non-terrestrial network, the method comprising: obtaining information for use in predicting a timing advance value to be used for communicating with a network node; acquiring a timing advance value, and deriving a predicted timing advance value based on the obtained information; and determining whether to transmit a timing advance report to the network node based on the acquired timing advance value and the predicted timing advance value.

In one aspect, the invention provides a method performed by a network node configured to communicate with a user equipment (UE) via a non-terrestrial network, the method comprising: transmitting, to the UE, information identifying a threshold associated with a timing advance value applicable for communications with the UE via the non-terrestrial network; acquiring a timing advance value for said communications with the UE; and receiving a timing advance report from the UE based on the threshold and a timing advance value acquired by the UE.

In one aspect, the invention provides a method performed by a network node configured to communicate with a user equipment (UE) via a non-terrestrial network, the method comprising: transmitting, to the UE, information for use in predicting a timing advance value to be used for communications between the UE and the network node; and receiving a timing advance report from the UE based on a timing advance value acquired by the UE and the predicted timing advance value.

In one aspect, the invention provides a user equipment (UE) configured to communicate via a non-terrestrial network, the UE comprising: means for obtaining information identifying a threshold associated with a timing advance value applicable for communications with a network node via the non-terrestrial network; means for acquiring a timing advance value for said communications with the network node; and means for determining whether to transmit a timing advance report to the network node based on the timing advance value and the threshold.

In one aspect, the invention provides a user equipment (UE) configured to communicate via a non-terrestrial network, the UE comprising: means for obtaining information for use in predicting a timing advance value to be used for communicating with a network node; means for acquiring a timing advance value, and for deriving a predicted timing advance value based on the obtained information; and means for determining whether to transmit a timing advance report to the network node based on the acquired timing advance value and the predicted timing advance value.

In one aspect, the invention provides a network node configured to communicate with a user equipment (UE) via a non-terrestrial network, the network node comprising: means for transmitting, to the UE, information identifying a threshold associated with a timing advance value applicable for communications with the UE via the non-terrestrial network; means for acquiring a timing advance value for said communications with the UE; and means for receiving a timing advance report from the UE based on the threshold and a timing advance value acquired by the UE.

In one aspect, the invention provides a network node configured to communicate with a user equipment (UE) via a non-terrestrial network, the network node comprising: means for transmitting, to the UE, information for use in predicting a timing advance value to be used for communications between the UE and the network node; and means for receiving a timing advance report from the UE based on a timing advance value acquired by the UE and the predicted timing advance value.

In one aspect, the invention provides a user equipment (UE) configured to communicate via a non-terrestrial network, the UE comprising a processor, a transceiver, and a memory storing instructions; wherein the controller is configured to: obtain information identifying a threshold associated with a timing advance value applicable for communications with a network node via the non-terrestrial network; acquire a timing advance value for said communications with the network node; and determine whether to transmit a timing advance report to the network node based on the timing advance value and the threshold.

In one aspect, the invention provides a user equipment (UE) configured to communicate via a non-terrestrial network, the UE comprising a processor, a transceiver, and a memory storing instructions; wherein the controller is configured to: obtain information for use in predicting a timing advance value to be used for communicating with a network node; acquire a timing advance value, and derive a predicted timing advance value based on the obtained information; and determine whether to transmit a timing advance report to the network node based on the acquired timing advance value and the predicted timing advance value.

In one aspect, the invention provides a network node configured to communicate with a user equipment (UE) via a non-terrestrial network, the network node comprising a processor, a transceiver, and a memory storing instructions; wherein the controller is configured to: control the transceiver to transmit, to the UE, information identifying a threshold associated with a timing advance value applicable for communications with the UE via the non-terrestrial network; acquire a timing advance value for said communications with the UE; and control the transceiver to receive a timing advance report from the UE based on the threshold and a timing advance value acquired by the UE.

In one aspect, the invention provides a network node configured to communicate with a user equipment (UE) via a non-terrestrial network, the network node comprising a processor, a transceiver, and a memory storing instructions; wherein the controller is configured to control the transceiver to: transmit, to the UE, information for use in predicting a timing advance value to be used for communications between the UE and the network node; and receive a timing advance report from the UE based on a timing advance value acquired by the UE and the predicted timing advance value.

Aspects of the invention extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### Terminology

TAC=Timing Advance Command
TAT=Time Alignment Timer (a timer that determines how long the TA can remain valid before the UE is considered to be out of sync).
NTA indicates an absolute TAC (it is initialised during initial access by a 12-bit number sent by the gNB in a random access response (RAR) message).
N_{TA_offset} is a 6-bit number that informs the UE about misalignment between the UE and the base station (N_{TA_offset} is sent by the gNB via an appropriate Medium Access Control Control Element (MAC CE) when the gNB detects misalignment; see 3GPP TS 38.213 V16.4.0 and 3GPP TS 38.321 V16.3.0). N_{TA_offset} may be used to update an old NTA used by the UE (N_{TA_new}=N_{TA_old}+N_{TA_offset}).
Common TA (precise definition not yet agreed by 3GPP):
   May be equal to the feeder link duration+service link duration to a reference point on Earth (see e.g. FIG. 6.3.4-1 of 3GPP TR 38.821).
   May refer to the feeder link RTD only (see e.g. 3GPP Draft R1-2102215).
K_offset (also referred to as “Common TA”) is common to all UEs in a cell and it is used as an offset (given as a number of subframes) for uplink misalignment before initial access (it may be updated after initial access; see 3GPP Draft R1-2102078).
K_mac: used by UE to adjust downlink response window in case of frame timing misalignment at the gNB side (when the UE is uplink synchronised but not frame synchronised).
‘Timing offset’ is a term used herein to describe the offset, in number of frames, used for uplink (UL) scheduling and downlink (DL) response windows (the UE and gNB can use the same timing offset, which may initially be equal to K_offset).

### BRIEF DESCRIPTION OF DRAWINGS

Embodiments of the invention will now be described, by way of example, with reference to the accompanying drawings in which:

FIG. 1 illustrates schematically a mobile (cellular or wireless) telecommunication system to which embodiments of the invention may be applied;

FIG. 2 is a schematic block diagram of a mobile device forming part of the system shown in FIG. 1;

FIG. 3 is a schematic block diagram of an NTN node (e.g. satellite/UAS platform) forming part of the system shown in FIG. 1;

FIG. 4 is a schematic block diagram of an access network node (e.g. base station) forming part of the system shown in FIG. 1;

FIG. 5 illustrates schematically feeder link round-trip-time change over time;

FIG. 6 illustrates schematically a Timing Advance adjustment procedure during initial access;

FIG. 7 is a flowchart illustrating schematically a Timing Advance update procedure performed by the mobile device; and

FIG. 8 illustrates schematically some exemplary architecture options for the provision of NTN features in the system shown in FIG. 1.

### DESCRIPTION OF EMBODIMENTS

### Overview

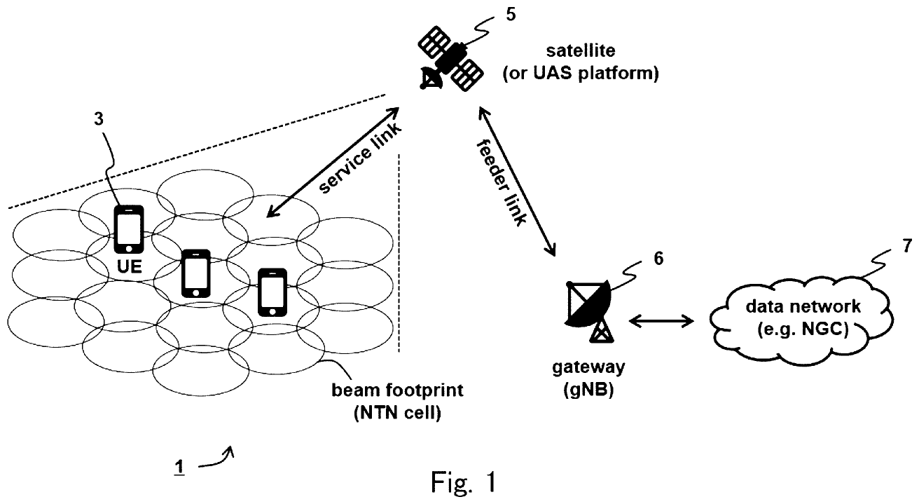

FIG. 1 illustrates schematically a mobile (cellular or wireless) telecommunication system 1 to which embodiments of the invention may be applied.

In this system 1, users of mobile devices 3 (UEs) can communicate with each other and other users via access network nodes respective satellites 5 and/or base stations 6 and a data network 7 using an appropriate 3GPP radio access technology (RAT), for example, an E-UTRA and/or 5G RAT. As those skilled in the art will appreciate, whilst three mobile devices 3, one satellite 5, and one base station 6 are shown in FIG. 1 for illustration purposes, the system, when implemented, will typically include other satellites/UAS platforms, base stations/RAN nodes, and mobile devices (UEs).

It will be appreciated that a number of base stations 6 form a (radio) access network or (R)AN, and a number of NTN nodes 5 (satellites and/or UAS platforms) form a Non-Terrestrial Network (NTN). Each NTN node 5 is connected to an appropriate gateway (in this case co-located with a base station 6) using a so-called feeder link and connected to respective UEs 3 via corresponding service links. Thus, when served by an NTN node 5, a mobile device 3 communicates data to and from a base station 6 via the NTN node 5, using an appropriate service link (between the mobile device 3 and the NTN node 5) and a feeder link (between the NTN node 5 and the gateway/base station 6). In other words, the NTN forms part of the (R)AN, although it may also provide satellite communication services independently of E-UTRA and/or 5G communication services.

Although not shown in FIG. 1, neighbouring base stations 6 are connected to each other via an appropriate base station to base station interface (such as the so-called ‘X2’ interface, ‘Xn’ interface and/or the like). The base station 6 is also connected to the data network nodes via an appropriate interface (such as the so-called ‘S1’, ‘NG-C’, ‘NG-U’ interface, and/or the like).

The data (or core) network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the data network 7 of a ‘Next Generation’/5G system will include user plane entities and control plane entities, such as one or more control plane functions (CPFs) and one or more user plane functions (UPFs). The data network 7 is also coupled to other data networks such as the Internet or similar Internet Protocol (IP) based networks (not shown in FIG. 1). Each NTN node 5 controls a number of directional beams via which associated NTN cells may be provided. Specifically, each beam has an associated footprint on the surface of the Earth which corresponds to an NTN cell. Each NTN cell (beam) has an associated Physical Cell Identity (PCI) and/or beam identity. The beam footprints may be moving as the NTN node 5 is travelling along its orbit. Alternatively, the beam footprint may be earth fixed, in which case an appropriate beam pointing mechanism (mechanical or electronic steering) may be used to compensate for the movement of the NTN node 5.

Due to the satellites' movement along their orbit, the distance between the UE 3 and its current NTN node 5 is changing relatively rapidly, which causes the characteristics (such as delay) of the service link to change accordingly. The characteristics of the feeder link change in a similar fashion due to the distance changing between the NTN node 5 and the base station 6 with the satellites' movement. These changes have an effect on the overall RTD between the UE 3 and the base station 6 and they require appropriate adjustments to the timing advance/time offset employed between them.

In order to support appropriate time and frequency synchronization between the UE 3 and the base station 6, when the UE 3 is connected via an NTN node 5 (in RRC Connected state) it is configured to perform UE specific TA calculations based at least on its GNSS-acquired position and the serving satellite's ephemeris. In order to update its TA in RRC Connected state, the UE 3 may use an open control loop (e.g. UE autonomous TA estimation, common TA estimation, etc.) or a closed control loop (e.g. received TA commands), or a combination thereof.

Specifically, the UE 3 is configured to employ one of the following approaches:
An optimised TAT value and a configurable threshold to minimise the need to report TA to the base station 6;
An optimised TAT value and a TA that is calculated autonomously and reported to the base station 6 only if the difference from the prediction would affect the Timing Offset beyond a configurable threshold; and
An optimised TAT value and a TA obtained using a prediction model that can be corrected over time (if necessary). The TA is only reported to the base station 6 the if difference from the prediction would affect the Timing Offset beyond a configurable threshold.

Beneficially, the above techniques allow reducing/minimising the signalling associated with TA update without causing misalignment between the UE 3 and the base station 6. Moreover, a reduced/more efficient timing offset signalling can be achieved by employing an implicit offset derivation technique from the UE's reported and/or predicted TA.

For example, in case of a UE 3 with good GNSS/autonomous TA update, no signalling is required (no TA reporting), unless the TA has an impact on the timing offset. The base station 6 may configure an appropriate (flexible) TAT value for the UE 3 depending on the situation which can further reduce signalling needed and/or improve TA correction by the UE 3.

Since the timing offset is derived from the (full) TA, if both the UE 3 and the base station 6 has this information, then there is no need to use signalling for the indicating the actual Timing Offset (implicit solution). If a prediction model is used, the timing offset can be updated with reduced/removed signalling.

### User Equipment (UE)

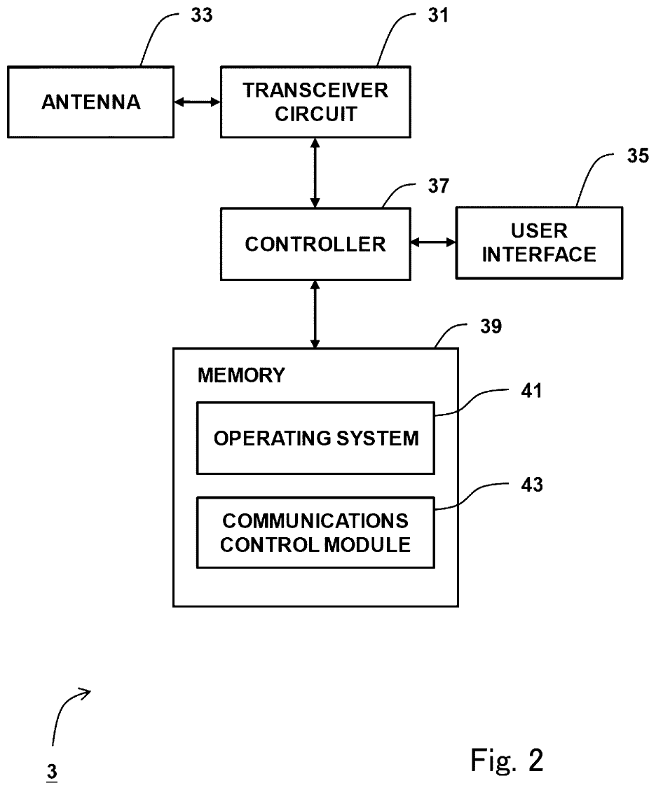

FIG. 2 is a block diagram illustrating the main components of the mobile device (UE) 3 shown in FIG. 1. As shown, the UE 3 includes a transceiver circuit 31 which is operable to transmit signals to and to receive signals from the at least one connected node via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, and a communications control module 43.

The communications control module 43 is responsible for handling (generating/sending/receiving) signalling messages and uplink/downlink data packets between the UE 3 and other nodes, including NTN nodes 5, (R)AN nodes 6, and core network nodes. The signalling may comprise control signalling related to time and frequency synchronization between the UE 3 and the base station/gateway 6.

### NTN Node (Satellite/UAS Platform)

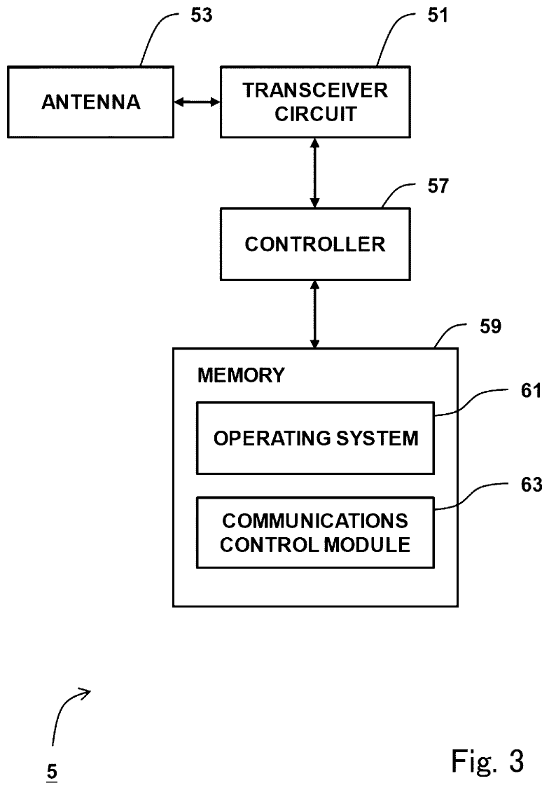

FIG. 3 is a block diagram illustrating the main components of the NTN node 5 (a satellite or a UAS platform) shown in FIG. 1. As shown, the NTN node 5 includes a transceiver circuit 51 which is operable to transmit signals to and to receive signals from at least one connected UE 3 via one or more antenna 53 and to transmit signals to and to receive signals from other network nodes such as gateways and base stations (either directly or indirectly). A controller 57 controls the operation of the NTN node 5 in accordance with software stored in a memory 59. The software may be pre-installed in the memory 59 and/or may be downloaded via the telecommunication network 1 or from a removable data storage device (RMD), for example. The software includes, among other things, an operating system 61, and a communications control module 63.

The communications control module 63 is responsible for handling (generating/sending/receiving) signalling between the NTN node 5 and other nodes, such as the UE 3, base stations 6, gateways, and core network nodes (via the base stations/gateways). The signalling may comprise control signalling related to time and frequency synchronization between the UE 3 and the base station/gateway 6.

### Base Station/Gateway (Access Network Node)

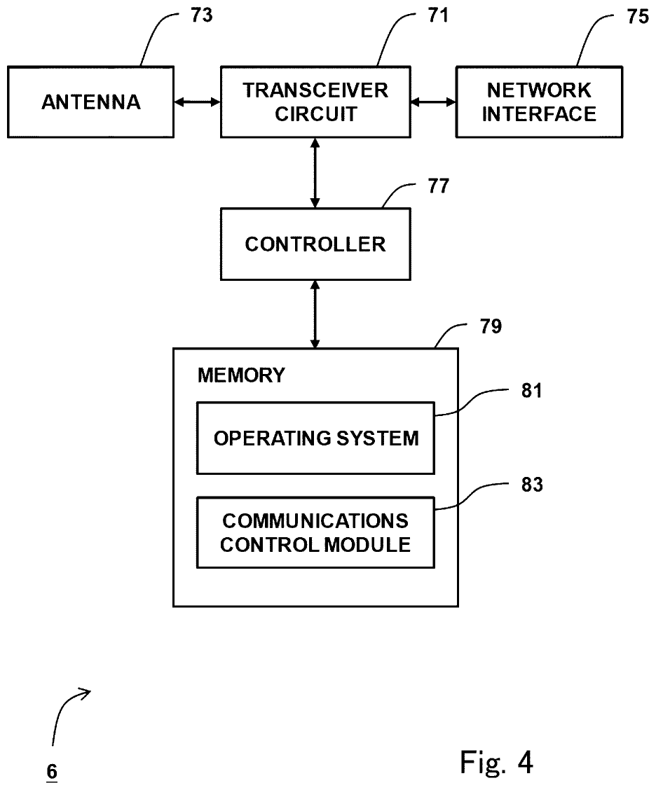

FIG. 4 is a block diagram illustrating the main components of the gateway 6 shown in FIG. 1 (a base station (gNB) or a similar access network node). As shown, the gateway/gNB 6 includes a transceiver circuit 71 which is operable to transmit signals to and to receive signals from at least one connected UE 3 via one or more antenna 73 and to transmit signals to and to receive signals from other network nodes (either directly or indirectly) via a network interface 75. Signals may be transmitted to and received from the at least one UE 3 either directly and/or via the NTN node 5, as appropriate. The network interface 75 typically includes an appropriate base station—base station interface (such as X2/Xn) and an appropriate base station—core network interface (such as S1/NG-C/NG-U). A controller 77 controls the operation of the base station 6 in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signalling between the base station 6 and other nodes, such as the UE 3, NTN nodes 5, and core network nodes. The signalling may comprise control signalling related to time and frequency synchronization between the UE 3 and the base station/gateway 6.

### DETAILED DESCRIPTION

It will be appreciated that the Timing Advance used by the UE 3 may be affected by (changes in) one or more of: the UE's position; the serving satellite's position; and the timing offset. Regarding these parameters, the following assumptions can be made:
The UE's position is not known by the base station 6 without heavy signalling (although position information may be required for other reasons than TA determination). Moreover, some UE's may not be able or configured to derive their position (or to provide it to the base station 6). However, the TA reporting process may give enough information to the base station 6 regarding the UE's position.
At least for initial access, the serving satellite's position may be acquired by the UE 3 from the satellite's ephemeris data, which also includes information identifying the satellite's future position (or path), and from which a service link specific portion of the full TA may be determined. The base station 6 may broadcast a Common TA parameter, which also includes TA information relating to the feeder link (which may be referred to as feeder link specific portion of the full TA).
The UE 3 and the base station 6 need to use the same Timing Offset (e.g. given by K_Offset=service link+feeder link delay). The base station 6 needs to know the position of the UE 3 (or at least its full TA) and the UE 3 needs to have information regarding the feeder link used by the base station 6 (which may not be as predictable as the service link). Typically, the base station 6 broadcasts information relating to the feeder link via system information, but the feeder link may not be known in advance.

In this system, it is possible to reduce/minimise signalling associated with TA update due to (a combination of) one or more key features.

Downlink TAC signalling may be reduced (or completely avoided) by having an accurate calculated or estimated TA, which may be achieved by the following features:
With GNSS capability, the UE 3 may always be UL synchronised (and the base station 6 needs to adjust the UE's TA only in case of a wrong estimation).
Without using GNSS during RRC Connected state, the UE 3 may still be able to be UL synchronised without the need of any signalling from the base station 6 for example by using an appropriate TA prediction model (broadcast by the base station 6 in system information or provided over-the-air).
In both cases, an accurate TA estimation can lead to potentially infinite TAT so there is no need for the base station 6 to transmit a TAC (or transmit TAC less frequently when the TAT is set to a relatively high value). It will be appreciated that the accuracy of TA estimation may vary (in time and per UE) but the TAT may be set to infinity if the TA estimation is good.

Uplink TA reporting may be reduced (or completely avoided) using an appropriate threshold:
The UE 3 may be configured to use GNSS and compare the GNSS based location information to the prediction model;
If the GNSS and prediction model based location is substantially the same, or the difference is within a threshold, the UE 3 can use either the GNSS based location information (for more precision and to avoid TA adjustment) or the prediction model for TA, and the offset information will be symmetrical.
   In order to achieve an efficient signalling of Timing Offset, the nodes of this system benefit from (a combination of) one or more of the following:
With legacy closed-loop control, the UE 3 is TA aligned and the base station 6 has perfect knowledge of the UE's situation for updating the Timing Offset if necessary. However, this approach requires a lot of DL signalling.
TA is much more sensitive to misalignment (0.52 μs) than timing offset (1 subframe or 1 ms).
As long as the UE's UL TA is correct, decodability/ISI is not an issue at the base station 6. Thus, the base station 6 may not need to be aware of the precise TA.

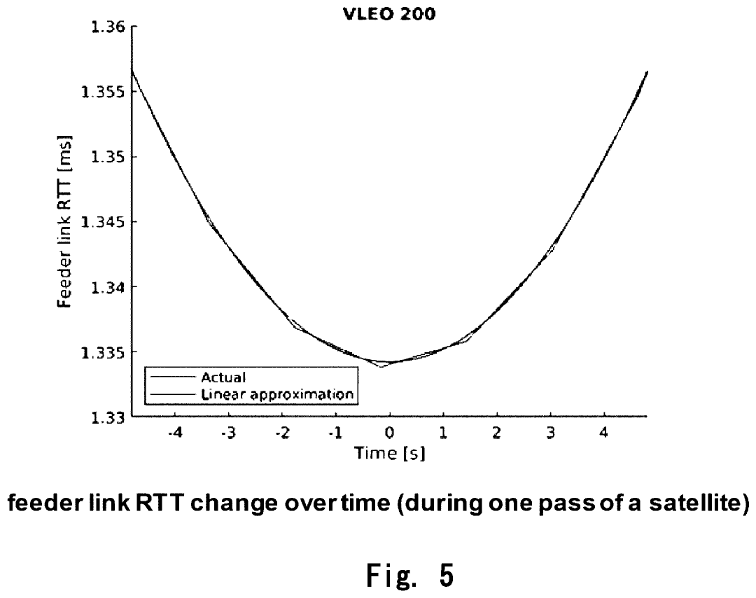

FIG. 5 illustrates schematically how a feeder link RTT changes over time, during one pass of a satellite (a VLEO 200 satellite in this example). It will be appreciated that the feeder link can be known in advance and it is regularly broadcast by the gNB. The service link will vary from UE to UE but it will have a similar U shape as the feeder link shown in FIG. 5. Hence it can be easily predicted (e.g. through trial and error but may be stored).

A benefit associated with using such prediction is that the UE 3 and the base station 6 have the same level of information, without signalling, by independently predicting the same TA. The UE 3 can be configured to make fine corrections to the TA while knowing if timing offset is affected by these corrections. The goal is to trigger fewer explicit TA or offset updates between the UE 3 and the base station 6.

The following is a description of some exemplary ways (Solutions 1 to 2b) in which the above procedure may be implemented in the system shown in FIG. 1.

### Solution 1: Minimal TA Reporting Using Reporting Threshold

In this case the initial access procedure is used to provide more efficient signalling options for the rest of the communication. The UE 3 can indicate either implicitly or explicitly whether it will do open-loop TA control or legacy closed-loop (e.g. to avoid using GNSS). Alternatively, in the absence of such indication from the UE 3, open-loop (or closed-loop) TA control may be applied by default. The base station 6 can set an appropriate TA reporting periodicity and at least one threshold and at least one TAT value, which may also be based on initial access TA correction.

The parameters may be modified later by the base station 6 if appropriate.

In this example, the UE 3 is configured to acquire its TA autonomously and only triggers a TA report when the acquired TA would affect the timing offset, as configured by an associated threshold provided by the base station 6.

Beneficially, only minimal and necessary TA reporting is performed between the UE 3 and the base station 6. The amount of TA updates and an appropriate TAT is set during initial connection setup.

### Solution 2

This solution also uses a prediction model. The parameters of the prediction model may be agreed upon during initial connection, they may be broadcasted, or stored in a database that the UE 3 can access. The base station 6 can update the parameters of the prediction model with time (when necessary). A few measurements (e.g. three) may be enough to provide a “U shape” interpolation curve (see FIG. 5) for predicting changes in the UE's TA over time.

The base station 6 and the UE 3 use a predicted TA (based on the same prediction model parameters) to derive the same Timing Offset and apply this offset when communicating with each other.

The UE 3 may use an estimated TA (e.g. derived using GNSS) or a predicted TA (e.g. corrected with TACs) to apply TA and remain UL synchronised with a relatively finer granularity.

It will be appreciated that an optimal change in the estimated Timing Offset may not occur at the same time as the one predicted and common with the base station 6. However, if it this stays within a margin of error (e.g. predicted=14.9 ms→offset=17 ms but estimated=15.3 ms) then there is no need to inform the base station 6 and the current offset can still be used.

The UE 3 is able to tell if its actual TA may differ from the predicted TA to a point where the agreed upon Timing Offset would be inappropriate (e.g. predicted=14.9 ms→offset=17 ms but estimated=17.3 ms) and in this case the UE 3 can inform the base station 6 that the current offset cannot be used. A large enough margin of error (i.e. predicted=14.9 ms→offset=15, 16, 17, 18 ms?) may reduce the need for signalling but it would further increase the associated round trip delay, which is already large in NTN.

In case the UE 3 needs to inform the base station 6 that the prediction model is too inaccurate, the prediction model is required to be updated at both the UE 3 and the base station 6 to allow for the same level of knowledge (and thus timing offset derivation).

### Solution 2a

In this case, the prediction model is used for Timing Offset derivation only. Both the UE 3 and the base station 6 have access to the same level of information (initial TA and prediction model), which are not affected by potential TAC misses. The UE 3 can use other TA estimation method (e.g. GNSS) to acquire an accurate TA. The UE 3 can derive which offset is used by the base station 6 (derived from the same predicted TA) and compare it with its accurately estimated TA (or with an offset derived from the estimated TA).

The UE 3 informs the base station 6 only if it determines that the derived offset at the base station 6 will not be appropriate (i.e. the prediction model is too far off). In most cases, even a slightly wrong prediction model with enough margin of error in the offset can still yield good results that would make the predicted offset appropriate.

A benefit associated with this solution is that it can further reduce (or completely remove) signalling related to TA reporting.

### Solution 2b

In this case, the prediction model is also used for actual TA adjustment. Both the UE 3 and the base station 6 have access to the same level of initial information (prediction model and initial TA). The UE 3 uses the predicted model to apply the TA. Consistent failure to decode TAC may cause a misalignment of TA information between the base station 6 and the UE 3 (e.g. the base station 6 may think the UE 3 corrected the TA three times, based on three TAC, when the UE failed to decode twice and only corrected once). However, misalignment of TA information will not affect the applied Timing Offset as it is derived from the prediction model.

Benefits associated with this solution include reduced signalling between the UE 3 and the base station 6, improves UE battery consumption (because no GNSS is required after initial access), and no need for GNSS related measuring gaps.

TA adjustment protocol: Initialisation (common to every solution)

The following initialisation procedure is common to the three solutions previously described, with the exception of the prediction model signalling at steps 2/7 which are optional in case of Solution 1.

In more detail, the initialisation stage comprises the following steps:
1. The UE 3 determines whether it is accessing an NTN cell (or a non-NTN cell, i.e. a terrestrial network cell). If the UE 3 is under the coverage of an NTN cell then it knows about satellite movement with regards to a reference location. This information may be obtained either via OTA configuration (from the core network using Non-Access Stratum signalling) or via broadcast signalling.
2. The UE 3 acquires information from the base station 6 (or from a database) related to an RTT prediction model to be used in the NTN cell, and an appropriate formula for deriving a Timing Offset from TA.
3. The UE 3 calculates (using an algorithm) an optimum uplink TA based e.g. upon its current location (derived using GNSS), broadcast information, and the data obtained as part of step 1.
4. The UE 3 applies the TA derived in step 2 and accesses the Random Access Channel (RACH). The UE 3 receives a Timing Advance Command as part of the RAR from the base station 6 (the value of TAC ranges from 0 to 1282 in case of RAR). The UE 3 adjusts the TA based on the TAC and applies the adjusted TA command to its uplink timing and starts an associated TAT. Even if NTA=0 timing alignment timer is still started.
5. The UE 3 informs the base station 6 about the TA that it uses (calculated in step 3).
6. The UE 3 indicates to the base station 6 what TA update mechanism it will be using (optionally including prediction model information, since the UE 3 may know its position and be able to set a more accurate prediction model).
7. As part of initial access handshake, the base station 6 indicates a dedicated TAT and optionally a TA reporting periodicity and/or threshold to be used by the UE 3 to trigger TA reporting.

### TA Adjustment Protocol: During RRC_CONNECTED (Solution 1)

The threshold to trigger TA reporting can be configured by the base station 6 (e.g. in step 7 above) or it may be a preconfigured for the UE 3. The threshold can be given as e.g. a certain difference in TA (value or percentage) since the last reporting or periodic timer. For instance, the threshold can be a point where a TA update would cause/require a Timing Offset change (which corresponds to the TA having changed by approximately 1 ms since last update).

This stage comprises the following steps:
8. Before time alignment timer expiry the UE 3 performs the following actions:
   a. Monitor new TA correction from the base station 6 (if any) and correct TA accordingly, for use in subsequent communication with the base station 6.
   b. If no correction received from the base station 6, update its calculated TA according to step 3 and use it during its subsequent communication with the base station 6.
   c. Derive a Timing Offset corresponding to the calculated TA using the formula from step 2.
   d. Apply offset derived at step 8.c during communication with the base station
6.
   e. If the autonomously calculated TA has changed above a threshold (configurable by the base station 6), update TA to the base station 6.
   f. After TA update, autonomously derive a corresponding offset and apply it during further communications with the base station 6.
9. Before time alignment timer expiry the base station 6 performs the following action:
   a. Monitor if TA needs to be adjusted and correct it if needed.
   b. Monitor UE for TA reporting.
   c. Update Timing Offset from step 9.b if new TA has been received from the UE
3.
   d. Apply updated Timing Offset from step 9.c during subsequent communications with the UE 3 (no need to signal the Timing Offset to the UE 3).
10. When a TA correction is received (before TAT expiry), the base station 6 may modify the TAT value and TA reporting periodicity/threshold depending on e.g. the TA correction value.
   TA adjustment protocol: During RRC_CONNECTED (Solution 2a)

In this case both the UE 3 and the base station 6 update the timing offset from the predicted model independently. Beneficially, the trigger to update TA can be looser and the UE 3 has the possibility to only report its TA if necessary (e.g. when inaccurate information at gNB side would impact validity of the offset). For instance, instead of “TA having changed by a certain value (e.g. 1 ms) since last update” the trigger may be “TA being farther than a certain value (e.g. 1 ms) compared to predicted TA”.

This stage comprises the following steps:
8. Before time alignment timer expiry the UE 3 performs the following actions:
   a. Monitor new TA correction from the base station 6 (if any) and correct TA accordingly.
   b. If no correction received from the base station 6, update its calculated TA according to step 3 and use it during its subsequent communication with the base station 6.
   c. Derive an estimated Timing Offset corresponding to the calculated TA using the formula from step 2.
   d. Monitor new prediction model correction from the base station 6 (if any) and correct prediction model accordingly.
   e. Calculate a predicted TA from step 2/7 and derive a predicted Timing Offset.
   f. Apply the predicted offset derived at step 8.d during subsequent communications with the base station 6.
   g. Condition to update TA to the base station 6: Autonomously calculated TA has changed above a threshold configurable by the base station 6, also taking into account the predicted TA. The UE 3 can assume that the base station 6 has the same predicted TA knowledge.
9. Before time alignment timer expiry the base station 6 performs the following actions:
   a. Monitor if TA needs to be adjusted and correct it if needed.
   b. Monitor UE for TA reporting.
   c. Update the prediction model with the TA from step 9.b and signal changes to the UE 3 (optional).
   d. Estimate predicted TA from step 2/7 with the current prediction model.
   e. Update the Timing Offset from the TA derived in step 9.d.
   f. Apply the Timing Offset from step 9.e during communication with the UE 3 (no need to signal the Timing Offset to the UE 3).
10. When a TA correction is received (before TAT expiry) the base station 6 may:
   a. Based on the TA correction (e.g. if its value is larger than a threshold), modify the prediction model taking into account this value.
   b. Modify the TAT value depending on the TA correction value.

TA adjustment protocol: During RRC_CONNECTED (Solution 2b) In this case the UE 3 uses its predicted TA for actual TA adjustment and the Timing offset is derived from a prediction model (instead of a predicted and corrected TA as above). This approach may be followed for example when an incremental TA adjustment is inaccurate due to the UE 3 missing or failing to decode one or more TACs. Beneficially, updates/corrections of the prediction model ensure an appropriate Timing Offset is always used.

This stage comprises the following steps:
8. Before time alignment timer expiry the UE 3 performs the following actions:
   a. Monitor new TA correction from the base station 6 (if any) and correct TA accordingly.
   b. Calculate a predicted TA from step 2/7 and derive a predicted Timing Offset using the formula from step 2.
   c. Apply the offset derived in step 8.b.
   d. Apply the TA from the predicted TA at step 8.b with corrections from TACs (if any) received during communication with the base station 6.
   e. Condition to update TA to gNB: predicted+corrected TA has changed above a threshold (configurable by the base station 6), also taking into account the predicted TA. The UE 3 can assume that the base station 6 has the same predicted TA knowledge (but not necessarily the predicted+corrected TA).
9. Before time alignment timer expiry the base station 6 performs the following actions:
   a. Monitor if TA needs to be adjusted and correct it if needed.
   b. Monitor UE for TA reporting.
   c. Update the prediction model with the TA from step 9.b and signal changes to the UE 3 (optional).
   d. Estimate predicted TA from latest prediction model (do not include TACs sent to the UE 3).
   e. Derive Timing Offset from the TA in step 9.d and apply it during communication with the UE 3.
10. When a TA correction is received (before TAT expiry) the base station 6 may:
   a. Based on the TA correction (e.g. if its value is larger than a threshold), modify the prediction model taking into account this value.
   b. Modify the TAT value depending on the TA correction value.

### Operation

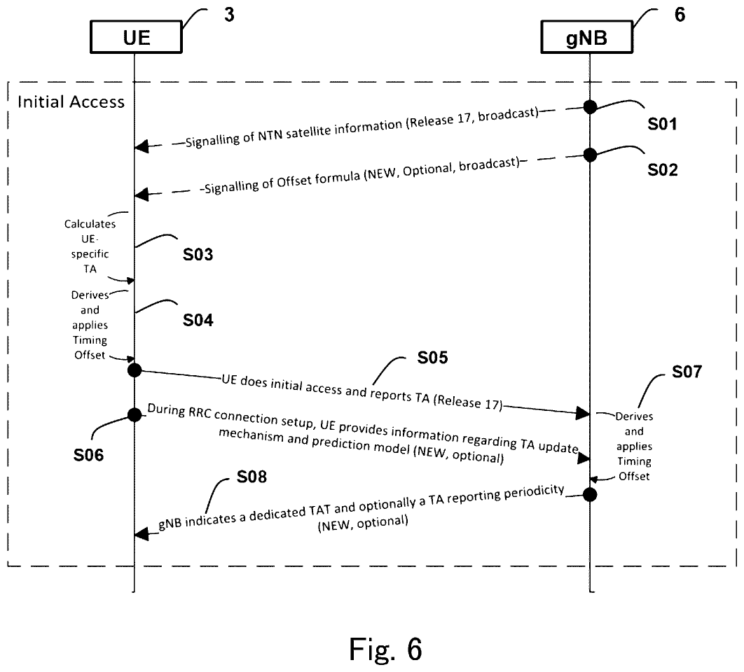

FIG. 6 illustrates schematically a Timing Advance adjustment procedure during initial access in a 5G (NR) radio access network. Effectively, the steps shown in FIG. 6 correspond to the overall procedure described above in the ‘TA adjustment protocol: Initialisation (common to every solution)’ section.

In this example, the base station or gNB 6 signals NTN satellite information to the UE 3 in step SOL. The NTN satellite information includes feeder link information, information relating to satellite movement with regards to a reference location.

Optionally, in step S02, the gNB 6 may also transmit the UE 3 information related to an RTT prediction model to be used in the NTN cell, and an appropriate formula for deriving a Timing Offset from TA. The information transmitted to the UE 3 may depend on the solution being used.

In step 503, the UE 3 calculates an optimum uplink TA (‘UE-specific TA’) based e.g. upon its current location (derived using GNSS if applicable), broadcast information, and the obtained NTN satellite information.

In step 504, the UE 3 derives and applies a Timing Offset based on the TA, then reports the TA to the gNB 6 in step S05 (e.g. as part of a RACH procedure).

Optionally, as generally shown in step S06, the UE 3 may also transmit information regarding the TA update mechanism and prediction model to be used.

Based on the TA from the UE 3, the gNB 6 also derives and applies a Timing Offset in step S07, and indicates an appropriate dedicated TAT value (optionally a TA reporting periodicity as well) to the UE 3 in step S08.

This completes the initialisation stage after which the UE 3 and the gNB 6 have applied the same TA value/Timing Offset and they have the same level of knowledge for subsequently updating the TA in accordance with the applicable TA adjustment protocol.

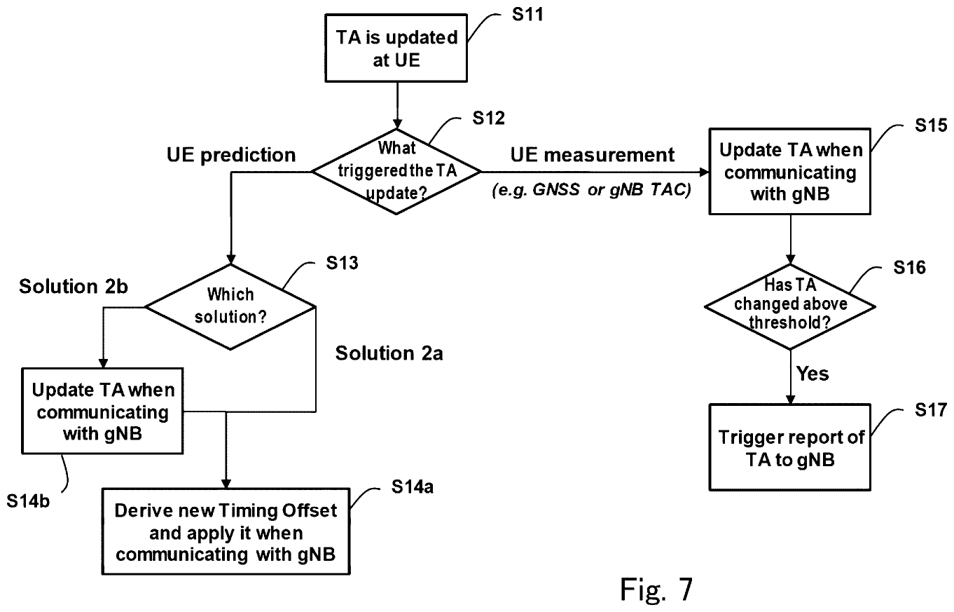

FIG. 7 is a flowchart illustrating schematically a Timing Advance update procedure performed by the mobile device during RRC Connected state (i.e. following initial access). Specifically, the flowchart illustrates an exemplary way in which the UE 3 determines when to transmit a TA report to the gNB 6 (e.g. based on a threshold in accordance with Solution 1, see step S16, or based on a prediction model as in Solution 2a or 2b). Whilst this flowchart illustrates various options such as ‘Solution 2a’ and ‘Solution 2b’, it will be appreciated that the UE 3 may be configured to carry out only one of the options in which case the branches of the flowchart corresponding to the other options shall be ignored. Alternatively, the steps relating to the UE prediction and UE measurement may be performed substantially concurrently when the UE 3 is configured to use GNSS measurements in addition to the prediction model.

### Modifications and Alternatives

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

It will be appreciated that the above embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

LEO satellites may have steerable beams in which case the beams are temporarily directed to substantially fixed footprints on the Earth. In other words, the beam footprints (which represent NTN cell) are stationary on the ground for a certain amount of time before they change their focus area over to another NTN cell (due to the satellite's movement on its orbit). From cell coverage/UE point of view, this results in cell changes happening regularly at discrete intervals because different Physical Cell Identities (PCIs) and/or Synchronization Signal/Physical Broadcast Channel (PBCH) blocks (SSBs) have to be assigned after each service link change, even when these beams serve the same land area (have the same footprint). LEO satellites without steerable beams cause the beams (cells) moving on the ground constantly in a sweeping motion as the satellite moves along its orbit and as in the case of steerable beams, service link change and consequently cell changes happen regularly at discrete intervals.

Similarly to service link changes, feeder link changes also happen at regular intervals due to the satellite's movement on its orbit. Both service and feeder link changes may be performed between different base stations/gateways (which may be referred to as an ‘inter-gNB radio link switch’) or within the same base station/gateway (‘intra-gNB radio link switch’). The above described methods may be performed at service and/or feeder link changes, if appropriate.

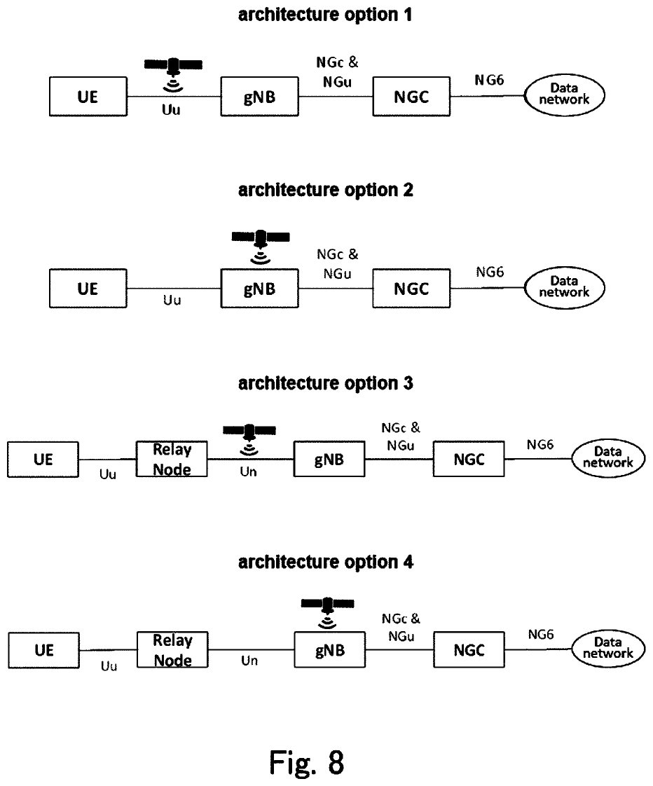

It will be appreciated that there are various architecture options to implement NTN in a 5G system, some of which are illustrated schematically in FIG. 8. The first option shown is an NTN featuring an access network serving UEs and based on a satellite/aerial with bent pipe payload and gNB on the ground (satellite hub or gateway level). The second option is an NTN featuring an access network serving UEs and based on a satellite/aerial with gNB on board. The third option is an NTN featuring an access network serving Relay Nodes and based on a satellite/aerial with bent pipe payload. The fourth option is an NTN featuring an access network serving Relay Nodes and based on a satellite/aerial with gNB. It will be appreciated that other architecture options may also be used, for example, a combination of two or more of the above described options. Alternatively, the relay node may comprise a satellite/UAS.

TABLE 1
types of satellites and UAS platforms

| | | | | Typical beam | |
|---|---|---|---|---|---|
| Platforms | Altitude range | | Orbit | footprint size | |
| Low-Earth Orbit | 300-1500 | km | Circular around the earth | 100-1000 | km |
| (LEO) satellite | | | | | |
| Medium-Earth Orbit | 7000-25000 | km | | 100-1000 | km |
| (MEO) satellite | | | | | |
| Geostationary Earth | 35 786 | km | Notional station keeping | 200-3500 | km |
| Orbit (GEO) satellite | | | position fixed in terms of | | |
| UAS platform | 8-50 km | | elevation/azimuth with | 5-200 | km |
| (including HAPS) | (20 km for HAPS) | | respect to a given earth point | | |
| High Elliptical Orbit | 400-50000 | km | Elliptical around the earth | 200-3500 | km |

(HEO) satellite

An appropriate TAT value may be configured by default in system information block type 1 (SIB 1) and it can be reconfigured when necessary, as described in 3GPP TS 38.331 V16.3.1. Specifically, the TAT can be (re)configured using an appropriate information element (IE) of the RRC Reconfiguration message (e.g. rrcReconfiguration IE>secondaryCellGroup IE>CellGroupConfig IE>mac-CellGroupConfig IE>TAG-Config IE>tag-ToAddMod IE>timeAlignmentTimer IE).

TAG-Config information element

-- ASN1START
-- TAG-TAG-CONFIG-START

| TAG-Config ::= | SEQUENCE { | |
|---|---|---|
| tag-ToReleaseList | SEQUENCE (SIZE (1..maxNrofTAGs)) OF TAG-Id | OPTIONAL, -- Need N |
| tag-ToAddModList | SEQUENCE (SIZE (1..maxNrofTAGs)) OF TAG | OPTIONAL -- Need N |

}

| | |
|---|---|
| TAG ::= | SEQUENCE { |
| tag-Id | TAG-Id, |
| timeAlignmentTimer | TimeAlignmentTimer, |

...
}

| | |
|---|---|
| TAG-Id ::= | INTEGER (0..maxNrofTAGs-1) |
| TimeAlignmentTimer ::= | ENUMERATED {ms500, ms750, ms1280, ms1920, ms2560, ms5120, ms10240, |

infinity}
-- TAG-TAG-CONFIG-STOP
-- ASN1STOP

The value of the TimeAlignmentTimer field is given in milliseconds. This allows a UE to be configured with a dedicated TAT (for a given cell/carrier) ranging between 500 ms to 10240 ms, or infinity.

In the above description, the UE, the NTN node (satellite/UAS platform), and the access network node (base station) are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the NTN node, and the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node, and the access network node (base station) in order to update their functionalities.

The above embodiments are also applicable to ‘non-mobile’ or generally stationary user equipment. The above described mobile device may comprise an MTC/IoT device and/or the like.

The method performed by the UE may further comprise deriving a timing offset for the communications with the network node based on the timing advance value.

The method performed by the UE may further comprise transmitting a timing advance report to the network node when it is determined that the timing advance value has changed over the threshold.

The method performed by the UE may further comprise obtaining a Time Alignment Timer (TAT) associated with the timing advance value.

The method performed by the UE may further comprise indicating whether the UE is configured to use an open-loop timing advance control or a closed-loop timing advance control.

The method performed by the UE may further comprise acquiring the timing advance value based on a location of the UE obtained using a Global Navigation Satellite System (GNSS). The method performed by the UE may further comprise acquiring the timing advance value based on a prediction model relating to at least one of a service link and a feeder link associated with said communications with the network node via the non-terrestrial network.

The information for use in predicting a timing advance value may comprise a set of parameters for predicting the timing advance (e.g. a prediction model). The set of parameters may be used for deriving a timing offset for communicating with the network node. The information (or parameters) for use in predicting a timing advance value may be transmitted by the network node at initial access or upon receiving a timing advance report from the UE.

The method performed by the network node may further comprise transmitting a TAT associated with the timing advance value to the UE.

The network node may comprise a gateway, a base station apparatus, or a satellite having a gateway or base station functionality.

Various other modifications will be apparent to those skilled in the art and will not be described in further detail here.

For example, the whole or part of the exemplary embodiments disclosed above can be described as, but not limited to, the following supplementary notes.

(Supplementary Note 1)

A method performed by a user equipment (UE) configured to communicate via a non-terrestrial network, the method comprising:
receiving, from a network node, information identifying a threshold associated with a respective timing advance value for communication with the network node via the non-terrestrial network;
acquiring a timing advance value for the communication; and
determining whether to transmit a timing advance report to the network node based on the timing advance value and the threshold.

(Supplementary Note 2)

The method according to note 1, further comprising deriving a timing offset for the communication based on the timing advance value.

(Supplementary Note 3)

The method according to note 1 or 2, further comprising:
determining whether the timing advance value has changed over the threshold; and
transmitting the timing advance report to the network node based on the determining whether the timing advance value has changed over the threshold.

(Supplementary Note 4)

The method according to any one of notes 1 to 3, further comprising receiving, from the network node, a Time Alignment Timer (TAT) associated with the timing advance value.

(Supplementary Note 5)

The method according to any one of notes 1 to 4, further comprising transmitting, to the network node, information indicating whether the UE is configured to use an open-loop timing advance control or a closed-loop timing advance control.

(Supplementary Note 6)

The method according to any one of notes 1 to 5, wherein the acquiring the timing advance value is performed based on a location of the UE obtained using a Global Navigation Satellite System (GNSS).

(Supplementary Note 7)

The method according to any one of notes 1 to 6, wherein the acquiring the timing advance value is performed based on a prediction model relating to at least one of a service link and a feeder link associated with the communication.

(Supplementary Note 8)

A method performed by a user equipment (UE) configured to communicate via a non-terrestrial network, the method comprising:
receiving, from a network node, information for predicting a timing advance value for communication with the network node;
acquiring a timing advance value;
deriving a predicted timing advance value based on the information; and
determining whether to transmit a timing advance report to the network node based on the timing advance value and the predicted timing advance value.

(Supplementary Note 9)

The method according to note 8, wherein the information includes a set of parameters for predicting the timing advance.

(Supplementary Note 10)

The method according to note 9, wherein the set of parameters is used for deriving a timing offset for the communication.

(Supplementary Note 11)

The method according to any one of notes 8 to 10, wherein the receiving the information is performed at initial access or in response to the transmitting the timing advance report.

(Supplementary Note 12)

A method performed by a network node configured to communicate with a user equipment (UE) via a non-terrestrial network, the method comprising:
transmitting, to the UE, information identifying a threshold associated with a respective timing advance value applicable for communication with the UE via the non-terrestrial network;
acquiring a timing advance value for the communication; and
receiving a timing advance report from the UE based on the threshold and the timing advance value.

(Supplementary Note 13)

The method according to note 12, further comprising transmitting a time alignment timer (TAT) associated with the timing advance value to the UE.

(Supplementary Note 14)

A method performed by a network node configured to communicate with a user equipment (UE) via a non-terrestrial network, the method comprising:
transmitting, to the UE, information for predicting a timing advance value for communication between the UE and the network node; and
receiving a timing advance report from the UE based on the predicted timing advance value.

(Supplementary Note 15)

The method according to note 14, wherein the transmitting the information is performed at initial access or upon receiving the timing advance report.

(Supplementary Note 16)

The method according to any one of notes 12 to 15, wherein the network node includes a gateway, a base station, or a satellite having a gateway or base station functionality.

(Supplementary Note 17)

A user equipment (UE) configured to communicate via a non-terrestrial network, the UE comprising:
means for receiving, from a network node, information identifying a threshold associated with a respective timing advance value for communication with the network node via the non-terrestrial network;
means for acquiring a timing advance value for the communication; and
means for determining whether to transmit a timing advance report to the network node based on the timing advance value and the threshold.

(Supplementary Note 18)

A user equipment (UE) configured to communicate via a non-terrestrial network, the UE comprising:
means for receiving, from a network node, information for predicting a timing advance value for communication with the network node;
means for acquiring a timing advance value;
means for deriving a predicted timing advance value based on the information; and
means for determining whether to transmit a timing advance report to the network node based on the timing advance value and the predicted timing advance value.

(Supplementary Note 19)

A network node configured to communicate with a user equipment (UE) via a non-terrestrial network, the network node comprising:
means for transmitting, to the UE, information identifying a threshold associated with a respective timing advance value applicable for communication with the UE via the non-terrestrial network;
means for acquiring a timing advance value for the communication; and
means for receiving a timing advance report from the UE based on the threshold and the timing advance value.

(Supplementary Note 20)

A network node configured to communicate with a user equipment (UE) via a non-terrestrial network, the network node comprising:
means for transmitting, to the UE, information for predicting a timing advance value for communication between the UE and the network node; and
means for receiving a timing advance report from the UE based on the predicted timing advance value.

This application is based upon and claims the benefit of priority from Great Britain Patent Application No. 2104780.8, filed on Apr. 1, 2021, the disclosure of which is incorporated herein in its entirety by reference.

### REFERENCE SIGNS LIST

1 Mobile telecommunication system
3 Users of mobile devices
5 Satellite
6 Base station
7 Data network
31 Transceiver circuit
33 Antenna
35 User interface
37 Controller
39 Memory
41 Operating system
43 Communications control module
51 Transceiver circuit
53 Antenna
57 Controller
59 Memory
61 Operating system
63 Communications control module
71 Transceiver circuit
73 Antenna
75 Network interface
77 Controller
79 Memory
81 Operating system
83 Communications control module

What is claimed is:

1. A method performed by a user equipment (UE) configured to communicate via a non-terrestrial network, the method comprising:
receiving, from a network node, information identifying a threshold associated with a respective timing advance value for communication with the network node via the non-terrestrial network; and
determining whether to transmit a timing advance report to the network node based on a timing advance value used for the communication and the threshold.

2. The method according to claim 1, further comprising deriving a timing offset for the communication based on the timing advance value.

3. The method according claim 1, further comprising:
determining whether the timing advance value has changed over the threshold; and
transmitting the timing advance report to the network node based on the determining whether the timing advance value has changed over the threshold.

4. The method according to claim 1, further comprising receiving, from the network node, a Time Alignment Timer (TAT) associated with the timing advance value.

5. The method according to claim 1, further comprising transmitting, to the network node, information indicating whether the UE is configured to use an open-loop timing advance control or a closed-loop timing advance control.

6. The method according to any claim 1, further comprising determining the timing advance value based on a location of the UE obtained using a Global Navigation Satellite System (GNSS).

7. The method according to claim 1, further comprising determining the timing advance value based on a prediction model relating to at least one of:
a service link, and
a feeder link associated with the communication.

8. A method performed by a user equipment (UE) configured to communicate via a non-terrestrial network, the method comprising:
receiving, from a network node, information for predicting a timing advance value for communication with the network node;
deriving a predicted timing advance value based on the information; and
determining whether to transmit a timing advance report to the network node based on a timing advance value used for the communication and the predicted timing advance value.

9. The method according to claim 8, wherein the information includes a set of parameters for predicting the timing advance value.

10. The method according to claim 9, wherein the set of parameters is used for deriving a timing offset for the communication.

11. The method according to claim 8, wherein the receiving the information is performed at initial access or in response to the transmitting the timing advance report.

12. A method performed by a network node configured to communicate with a user equipment (UE) via a non-terrestrial network, the method comprising:
transmitting, to the UE, information identifying a threshold associated with a respective timing advance value for communication with the UE via the non-terrestrial network;
receiving, from the UE, a timing advance value for the communication; and
receiving a timing advance report from the UE based on the threshold and the timing advance value.

13. The method according to claim 12, further comprising transmitting a time alignment timer (TAT) associated with the timing advance value to the UE.

14. A method performed by a network node configured to communicate with a user equipment (UE) via a non-terrestrial network, the method comprising:
transmitting, to the UE, information for predicting a timing advance value for communication between the UE and the network node; and
receiving a timing advance report from the UE based on the predicted timing advance value.

15. The method according to claim 14, wherein the transmitting the information is performed at initial access or upon receiving the timing advance report.

16. The method according to claim 12, wherein the network node includes a gateway, a base station, or a satellite having a gateway or base station functionality.

17. A user equipment (UE) configured to communicate via a non-terrestrial network, the UE comprising:
a memory storing instructions; and
at least one processor configured to process the instructions to:
receive, from a network node, information identifying a threshold associated with a respective timing advance value for communication with the network node via the non-terrestrial network; and
determine whether to transmit a timing advance report to the network node based on a timing advance value used for the communication and the threshold.

18. A user equipment (UE) configured to communicate via a non-terrestrial network, the UE comprising:
a memory storing instructions; and
at least one processor configured to process the instructions to:
receive, from a network node, information for predicting a timing advance value for communication with the network node;
derive a predicted timing advance value based on the information; and
determine whether to transmit a timing advance report to the network node based on a timing advance value used for the communication and the predicted timing advance value.

19. A network node configured to communicate with a user equipment (UE) via a non-terrestrial network, the network node comprising:
a memory storing instructions; and
at least one processor configured to process the instructions to:
transmit, to the UE, information identifying a threshold associated with a respective timing advance value for communication with the UE via the non-terrestrial network;
receive, from the UE, a timing advance value for the communication; and
receive a timing advance report from the UE based on the threshold and the timing advance value.

20. A network node configured to communicate with a user equipment (UE) via a non-terrestrial network, the network node comprising:
a memory storing instructions; and
at least one processor configured to process the instructions to:
transmit, to the UE, information for predicting a timing advance value for communication between the UE and the network node; and
receive a timing advance report from the UE based on the predicted timing advance value.
